(19) United States
(12) Patent Application Publication
(10) Pub. No.: US 2008/0049755 A1
(43) Pub. Date: Feb. 28, 2008

(54) METHOD AND SYSTEM FOR OPTIMIZING RESOURCE ALLOCATIONS BASED ON QUALITY OF SERVICE NEEDS OF ONE OR MORE APPLICATIONS

(75) Inventors: Mark A. Gannon, Sleepy Hollow, IL (US); Rod N. Averbuch, Buffalo Grove, IL (US); Donald A. Dorsey, Vernon Hills, IL (US); Barry J. Menich, South Barrington, IL (US); Kenneth J. Zdunek, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/467,211

(22) Filed: Aug. 25, 2006

(51) Int. Cl. H04J 1/16; H04L 12/56; H04J 3/22

(52) U.S. Cl. 370/395.1; 370/252; 370/468

(57) ABSTRACT

A method and system for optimizing a Quality of Service (QoS) for an application is provided. The method comprises generating (205) a dynamic database (110 or 150) of statistical information regarding at least one of the applications and one or more communication network (115, 120 and 125). Further, the method comprises selecting (210) the application to operate on the communication network. The dynamic database is then analyzed (215) to determine at least one network configuration based on desired QoS requirement. Based on the analysis of at least one network configuration a connection (220) is made to the requested application.

### FIELD OF THE PRESENT INVENTION

The present invention generally relates to Quality of Service (QoS). More specifically, the present invention relates to a method and system for optimizing resource allocations for one or more applications based on the QoS needs of the one or more applications and the QoS observations.

### BACKGROUND OF THE PRESENT INVENTION

Today, the requirement for next-generation, service-capable communication networks are driven by applications, specific Quality of Service (QoS) requirements per application and a need to manage sessions with one or more clients. In the existing communication networks, one or more clients can send packet-based service requests for accessing one or more applications such as VoIP, Video conferencing, Video On Demand (VOD) or interactive games. The packet-based service requests are allowed on a per connection basis in the communication network. That is, the packet-based service requests are queued in the communication network for accessing the one or more applications.

Each application may require a certain a QoS. For example, an application such as a Voice over Internet Protocol (VoIP) requires that the session be subjected to minimal delay. Additionally, the VoIP application must sustain minimal packet loss to retain a high metal oxide semiconductor (MOS) score. Thus, a VoIP application may require its QoS to be a real-time constant bit rate (CBR) or a real-time variable bit rate (VBR-RT).

However, the queued packet-based service requests are served based on a plurality of parameters. For example, one of the parameters is the network traffic. An increasing number of clients in a communication network severely constrain the communication network bandwidth. The QoS of any communication network is critically influenced by the clients' traffic patterns. In a limited bandwidth communication network the client can consume a major portion of the bandwidth of the communication network when a client downloads or streams multimedia applications that have a large file size. This adversely reduces the bandwidth availability for other clients. Moreover, the increase of network traffic creates several other issues such as dropping packets, out-of-order packet deliveries, delays, jitters, out-of-order deliveries and errors that contribute to degradation in the QoS of the communication network. If a router in the communication network is not able to receive or deliver packets, the packets may be dropped if the router's buffer is full. In such situations, clients may request the application servers to re-transmit the packets. As a consequence, severe delays may be experienced in the overall transmission of the packets from the application servers to the clients, thus decreasing the QoS of an application.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a client in communication with an application server, in accordance with an embodiment of the present invention.

FIG. 2 is a flow diagram of a method of optimizing a Quality of Service (QoS) for one or more applications accessible by access points into a communication network, in accordance with an embodiment of the present invention.

FIG. 3 is a flow diagram of a method of generating a dynamic database, in accordance with an embodiment of the present invention.

FIG. 4 is a flow diagram for customizing the QoS for one or more applications, in accordance with an embodiment of the present invention.

FIG. 5 is a flow diagram for a method of managing a request for obtaining desired-traffic-characteristics for an application, in accordance with an embodiment of the present invention.

FIG. 6 is a block diagram of a system that facilitates optimization of a Quality of Service (QoS) for one or more applications, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PRESENT INVENTION

Before describing in detail embodiments that are in accordance with the present invention, it should be observed that the embodiments reside primarily in combinations of method steps and apparatus components related to optimizing resource allocations for applications based on QoS needs of one or more applications. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the present invention described herein may be comprised of one or more conventional processors and unique stored program instructions that control the one or more processors to implement, in conjunction with certain non-processor circuits, some, most, or all of the functions of method and system for optimizing resource allocations for applications based on QoS needs of one or more applications described herein. The non-processor circuits may include, but are not limited to, a radio receiver, a radio transmitter, signal drivers, clock circuits, power source circuits, and user input devices. As such, these functions may be interpreted as steps of a method to perform optimizing resource allocations for applications based on QoS needs of one or more applications. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments of the present invention provide a method and system for optimizing a Quality of Service (QoS) for an application that is accessible through a communication network by a client. The method comprises generating a dynamic database of statistical information pertaining to one or more applications or pertaining to one or more communication networks. Subsequently, an application is selected from the one or more applications to operate on a communication network from the one or more communication networks. Moreover, based on a desired QoS requirement of the application, one or more network configurations are determined by analyzing the dynamic database. On determining the one or more network configurations, a connection is established between the client and the application using the one or more network configurations.

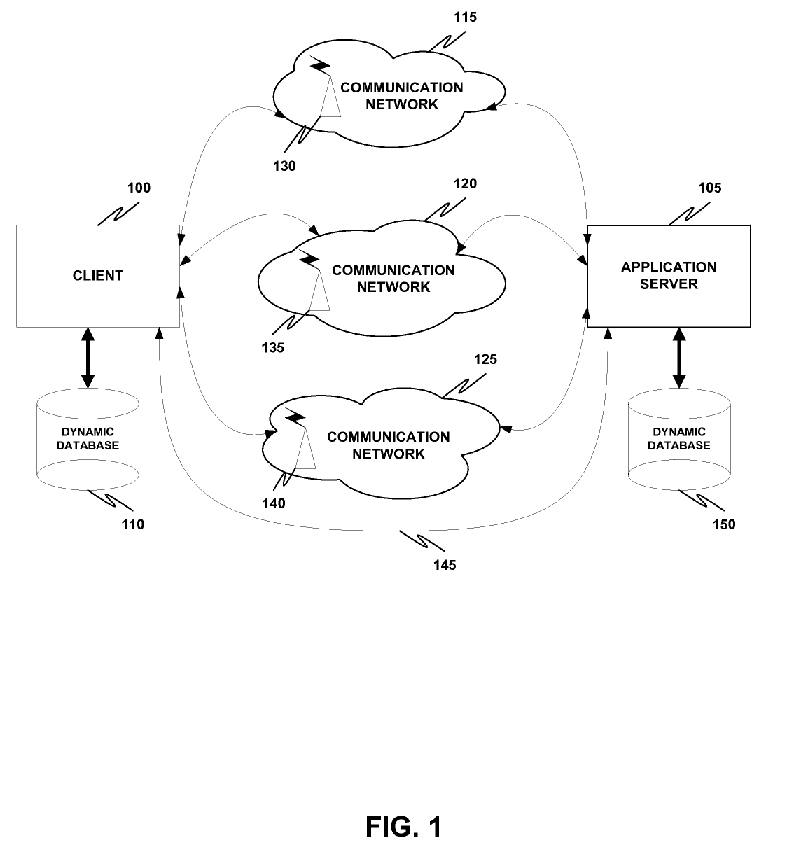

Referring now to FIG. 1, a client in communication with an application server is shown in accordance with an embodiment of the present invention. A plurality of clients can be in communication with an application server using access points into various communication networks. One of the plurality of clients is depicted as client 100. The client 100 may request for an application service from an application server 105. For example, the client 100 can request for a VoIP service from a VoIP server, or a gaming service from a game server. In accordance with an embodiment of the present invention, the client 100 can be coupled to a dynamic database 110 that is organized based on a predefined structure. The dynamic database 110 can store historical measurements of sessions that the client 100 had in the past corresponding to one or more applications. The historical measurements may comprise of a plurality of statistical elements such as, a client Identity (ID), network IDs corresponding to one or more networks, application IDs corresponding to one or more applications, session IDs corresponding to sessions between the client 100 and the one or more applications, one or more protocol stacks used, one or more destinations, application behavior of the one or more applications, time and day, network resource availability, quality and characteristics of the physical network resource available, duration of the sessions and location. Furthermore, the dynamic database 110 may comprise of historical measurements with respect to client behavior pattern of the client 100 in accessing one or more applications from the one or more communication networks.

In one embodiment of the present invention, the client ID can be associated with one or more clients who may share a same end unit. The end unit can be a personal computer, a cellular phone or a PDA (Personal Data Assistant). The network ID can be related to, for instance, CDMA (Code Division Multiple Access) IX data, EV-DO (Evolution-Data Optimized), iDEN™ (Integrated Digital Enhanced Network) data, UMTS (Universal Mobile Telecommunications System) or any other operator. An application ID is unique for a specific application and may relate to, but is not limited to, a web browser, an MP3 stream player or a video stream player. The session ID may be associated to, for instance, audio or video streaming, image downloading that may be integrated and embedded into an application corresponding to the session. Furthermore, the statistical elements pertaining to protocol stack used may comprise all available layers beneath the application such as TCP/IP (Transmission Control Protocol/Internet Protocol), UDP/IP (User Datagram Protocol/Internet Protocol), HTTP (Hypertext Transfer Protocol), FTP (File Transfer Protocol), RTSP/RTP (Real Time Streaming Protocol), or any other protocol stack. The statistical elements related to an application behavior may comprise rate, rate of variation and delay. Statistical measurements regarding the network resource availability may comprise information about bandwidth availability. The location statistical information can comprise mobile station ID, operator and GPS coordinates.

The dynamic database 110 can be updated periodically. The client 100 can register information pertaining to the various statistical elements with the dynamic database 110, which is described in more detail below. Prior to application activation, the client 100 can query the dynamic database 110 for retrieving historical information corresponding to the application. The client 100 can retrieve historical information in order to select, for instance, an optimal communication network, an optimal application configuration, a proper QoS request from the communication network or a general application admission control. Further, the general application admission control may comprise accepting a request, rejecting a request, delaying a request or offering an alternative application. A plurality of communication networks, for example a communication network 115, a communication network 120 and a communication network 125 can be available through which the client 100 can access the application server 105. Those skilled in the art will realize that more than three communication networks may also be available and all such embodiments are within the scope of the present invention. The communication networks can be, for instance, a LAN (Local Area Network), a WLAN (Wireless Local Area Network), a RAN (Radio Area Network), a MAN (Metropolitan Area Network) or a WAN (Wide Area Network).

The dynamic database 110 can comprise historical information about sessions that the client 100 had in the past using each of the communication network 115, the communication network 120 and the communication network 125. The client 100 can select one of the communication networks 115, the communication network 120 and the communication network 125 based on the historical information retrieved from the dynamic database 110. For instance, if historical information implies that under certain circumstances, the client 100 had a better QoS while using the communication network 115 than while using the communication network 120 and the communication network 125, then the client 100 can select the communication network 115. Moreover, the client 100 can select a communication network based on the desired results. In an embodiment of the present invention, the historical measurements regarding the various statistical elements are obtained during connection to an access point 130 of communication network 115, an access point 135 of the communication network 120 or an access point 140 of the communication network 125. This may require an interface between the communication network 115, the communication network 120 and the communication network 125 and the application server 105.

In an embodiment of the present invention, the client 100 may want to play a game over a communication network. An average network bandwidth of 100 kbps (kilobits per second) may be required for playing the interactive game over a communication network. When the client 100 intends to play the game by choosing the best communication network, the client 100 queries the dynamic database 110 for retrieving the historical measurements. By virtue of the historical measurements in the dynamic database 110, the client 100 has the knowledge that an average bandwidth of 102 kbps can be achieved if the communication network 120 is used. Further, the client 100 has the knowledge that an average bandwidth of 75 kbps can be achieved if the communication network 115 is used. The knowledge about the bandwidth offered by the different communication networks is stored in the dynamic database 110. Using this knowledge, the client 100 decides to play the game over the communication network 120, since communication network 120 offers a higher bandwidth.

The application server 105 can be interfaced through one or more access points to establish communication links to various communication networks. For instance, the application server 105 can be interfaced through the access point 130 to the communication network 115, through the access point 135 to the communication network 120 and through the access point 140 to the communication network 115. Through the communication links, the application server 105 can receive requests from a plurality of clients and transmit data pertaining to the requested applications. Further, the application server 105 may also be directly interfaced with the client 100 through a communication link 145. The communication link 145 can be a wired or a wireless medium. Information pertaining to the application usage, configuration and performance statistics can be obtained from the application server 105. Those skilled in the art will realize that the application server 105 can host one or more applications. In an embodiment of the present invention, an analysis based on the historical measurements relating to QoS is performed at a plurality of clients. The application server 105 can serve one or more applications to a plurality of client requests based on this analysis.

In an embodiment of the present invention, the application server 105 can be coupled to a dynamic database 150 that is organized based on a predefined structure. Further, the dynamic database 150 can store historical measurements dynamically. The historical measurement may comprise of a plurality of statistical elements. For example, the statistical elements may include a client ID, a network ID, an application ID, a session ID corresponding to a session between a client and the application server 105, protocol stack used, destination, application behavior, time and day, network resource availability and location. Moreover, the dynamic database 150 may also comprise historical measurements with respect to client behavior pattern in accessing one or more applications from the application server 105. The application server 105 can register information pertaining to the various statistical elements in the dynamic database 150. The application server 105 can later query the dynamic database 150 for retrieving historical information prior to application activation by the client 100.

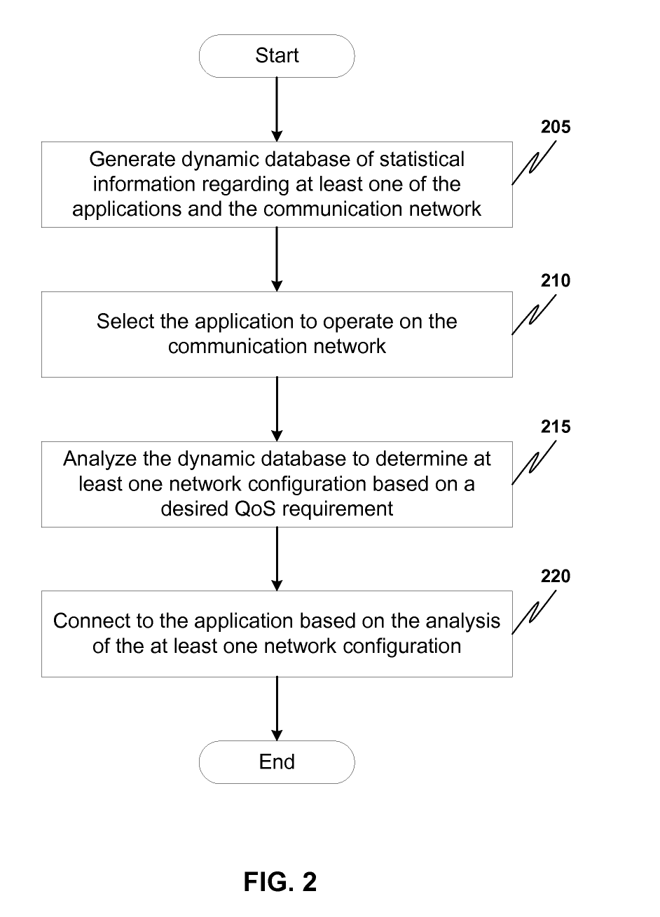

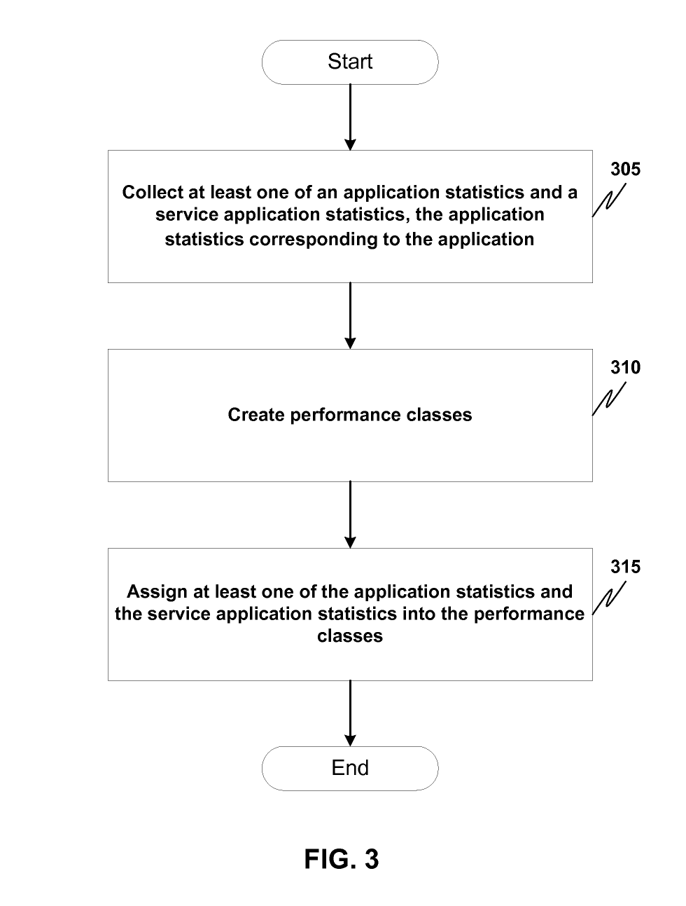

Turning now to FIG. 2, a flow diagram of a method of optimizing a QoS for one or more applications accessible by access points into a communication network is shown in accordance with an embodiment of the present invention. Those skilled in the art will realize that the QoS can be a predefined set of statistics corresponding to an application. A dynamic database of statistical information pertaining to one or more applications or pertaining to one or more communication networks, for instance the dynamic database 110 or the dynamic database 150, is generated 205. A method for generating the dynamic database is described in detail in conjunction with FIG. 3. Those skilled in the art will realize that more than one dynamic database can be generated at various nodes in the communication network. However, for the sake of clarity, the present embodiment deals with a single dynamic database being generated. The dynamic database can be updated periodically, based on the condition of the communication networks or of the application services.

The client 100 selects 210 an application to operate in a communication network. Further, the dynamic database is analyzed 215 for determining one or more communication network configuration based on the QoS required by the application. For this purpose, the QoS required by the application is matched with the statistical information about the application present in the dynamic database. One or more parameters of the application can then be configured based on the required QoS. The analysis of the dynamic database for determining one or more communication network configuration may comprise selecting a communication network from among a plurality of communication networks, such as the communication network 115, the communication network 120 and the communication network 125, modification of an activity factor for use by a scheduler specific to the application's historical requirements, relaxation or increase of the Block Error Rate (BLER) targets to meet the QoS as measured by the edges of the application, or proactive network reconfiguration based on the historical characterizations of the QoS. Based on the analysis of one or more communication network configuration, the client 100 is connected 220 to the requested application. Furthermore, the dynamic database can be updated based on this connection.

In an embodiment of the present invention, the dynamic database can reside on the client, for instance the dynamic database 110. In this case, the steps 205, 210, 215 and 220 can occur at the client 100. In another embodiment of the present invention, the dynamic database can reside on an access point, such as the access point 130, the access point 135 or the access point 140, which connects the application server 105 to the communication networks, such as the communication network 115, the communication network 120 or the communication network 125. In this case, the access point generates 205 the dynamic database, the client selects 210 the application, the access point analyzes 215 the dynamic database, and the access point connects 220 the client to the application based on the analysis. In an embodiment of the present invention, the access point may temporarily reject use of the application due to anticipated poor performance in a loaded communication network condition or limited capability communication network. In another embodiment of the present invention, the access point may offer a different application, which provides similar capability as the application selected by the client, based on the statistics.

Turning now to FIG. 3, a method of generating the dynamic database 110 is shown in accordance with an embodiment of the present invention. Those skilled in the art will realize that the dynamic database 150 can also be generated using this method, however, generation of the dynamic database 110 is considered for the sake of clarity. Referring back to FIG. 2, generating 205 the dynamic database 110 comprises collecting 305 an application statistics or a service application statistics in the dynamic database 110. The application statistics corresponds to one or more applications operating at one or more clients and the service application statistics corresponds to one or more service applications being deployed at the application server 105. The application statistics collected may correspond to a plurality of applications operating at a plurality of clients. In an embodiment of the present invention, statistics pertaining to client behavior can be collected through learning algorithms. The learning algorithms can be, for instance, based on statistical methods such as linear regression and logistical regression. Moreover, the learning algorithms can also be based on non-statistical methods such as neural networks and self-organizing maps. Based on the client behavior statistics a classification can be made among the different types of recorded client behavior. From the client behavior statistics, an estimation can be obtained for reserving a plurality of network resources to a plurality of clients. For example, one or more clients may be classified as heavy network resource consumers. Consequently, a certain percentage of the network resources can be reserved for such clients.

The application statistics and the service application statistics can be collected periodically at a predefined time interval. Further, the application statistics may comprise one or more client identification, an application identification, an identification corresponding to one or more communication networks, a session identification, a session duration corresponding to the session, a location of the client, a usage frequency of the application, a resource availability in one or more communication networks, a historical measurement of traffic corresponding to the service application, an application type and a client type.

The service application statistics collected corresponds to one or more service applications that can be deployed at the application server 105. Further, the service application statistics may comprise one or more service application identification, an identification corresponding to one or more communication networks, a session identification, a session duration corresponding to the session, a location of the application server 105, a throughput measurement of the service application, a time of the day corresponding to the session, a historical measurement of traffic corresponding to the service application, a resource availability in one or more communication networks, one or more communication networks load measurement or indication, a service application type and an application server type.

Further, one or more performance classes are created 310 based on the collected application statistics and the service application statistics. The performance classes are used to categorize the collected application statistics and the service application statistics based on the QoS of previous sessions. The performance classes can enable the client 100 to choose the application statistics and the service application statistics to obtain the desired QoS for the application requested by the client 100. The one or more performance classes can be matched with the QoS required by the application based on a plurality of guidelines. The plurality of guidelines may comprise minimizing a total per flow delay in the session, minimizing a plurality of jitter instances in the session or comparing a throughput requirement in QoS with one or more network resources. The application statistics and the service application statistics in the dynamic database 110 are assigned 315 to the one or more performance classes. A self-learning algorithm can be used for assigning the application statistics and the service application statistics to the one or more performance classes. Those skilled in the art will realize that the self-learning algorithm can enable the dynamic database 110 by adapting to the plurality of guidelines. Referring back to FIG. 2, the network configuration can be selected 210 based on the performance class that matches the QoS requirement of the application selected by the client 100.

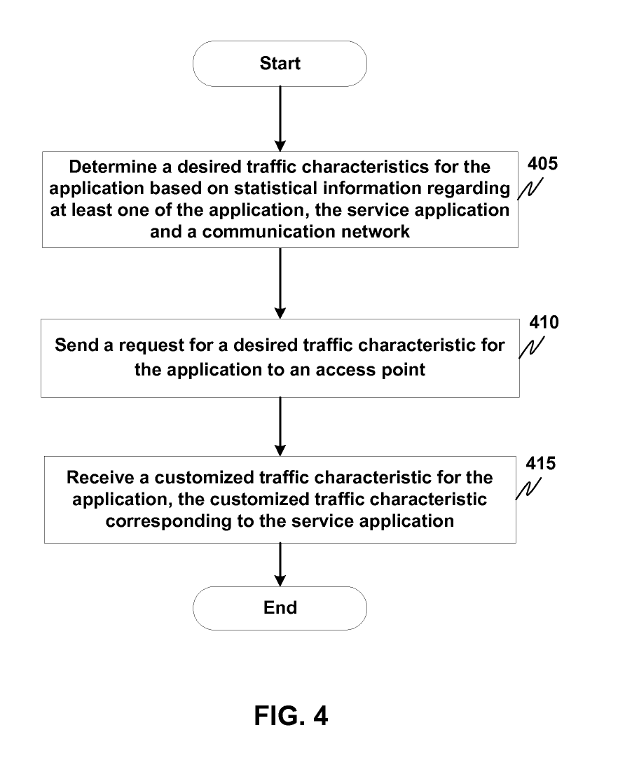

Turning now to FIG. 4, a flow diagram for customizing a QoS for an application is shown in accordance with an embodiment of the present invention. The client 100 may wish to operate the application. The application may need a desired traffic characteristics for optimum QoS. The client 100 can determine 405 the desired traffic characteristics for the application based on statistical information regarding at least one of the application, the service application and a communication network. The desired traffic characteristic corresponds to a service application serving the application at the application server 105. The statistical information can be stored in the dynamic database 110. Moreover, the client 100 can also select the communication network 115 to access the application server 105. On determining the desired traffic characteristics, the client 100 requests the access point 130 for the desired traffic attributes based on the historical measurements of the traffic corresponding to the service application. The client 100 sends 410 a request to the access point 130 corresponding to the communication network 115 for the desired traffic characteristic for the application selected by the client 100. In response to sending the request, the client 100 receives 415 a customized traffic characteristic for the application. The client 100 can then accept the customized traffic characteristics or reject the customized traffic characteristics. For instance, the client 100 may request the application server 105 for a multimedia application with video and audio capabilities. Depending on the current load conditions in the network, the access point 130 between the client and the communication network 115 may customize the multimedia application to provide only an audio-only version of the multimedia application. The client 100 can then either accept the audio-only version of the multimedia application. Alternatively, the client 100 can reject the audio-only version of the multimedia application.

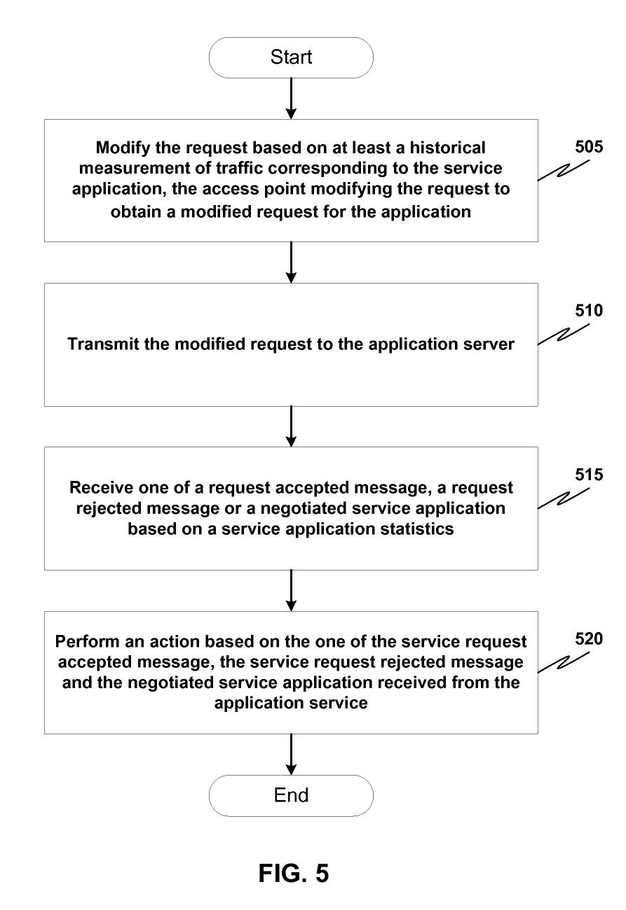

Turning now to FIG. 5, a flow diagram for a method of managing a request for obtaining a desired traffic characteristic for an application is shown. The client 100 may wish to access the application from the application server 105 via the communication network 115. The application may need a desired tariff characteristic to obtain an optimum QoS. As mentioned in FIG. 4, the client 100 sends a request to an access point 130 of the communication network 115 for the desired traffic characteristic for the application. In an embodiment of the present invention, the client 100 may determine the desired traffic characteristics based on application statistics in the dynamic database 110. In another embodiment of the present invention, the client 100 can request the access point 130 for the desired traffic characteristics based on a historical measurement of traffic corresponding to the application.

The request received by the access point 130 is modified 505 based on the historical measurements of the traffic corresponding to the service application deployed at the application server 105. The historical information can be retrieved from the dynamic database 150 or the dynamic database 110. The access point 130 transmits 510 a modified request to the application server 105. The access point 130 then receives 515 a service request accepted message, a service request rejected message or a negotiated service application based on a service application statistics. For example, if the application server 105 determines that the desired traffic characteristics can be granted to the application, the application server 105 accepts the request and sends the request accepted message to the access point 130. If, however, the application server 105 determines that the desired traffic characteristics cannot be granted to the application, the application server 105 sends the request rejected message to the access point 130. In an embodiment of the present invention, a dynamic database may reside on the client 100 as well as on the access point 130 in the communication network 115. At least one of the client 100 and the application server 105 can operate on a protocol with the access point 130 to negotiate session elements based on statistical information in the dynamic databases. This approach allows faster and refined decision which takes into account statistical data of both the dynamic databases.

Based on the modified request and the service application statistics, the application server 105 negotiates the service application with the access point 130 to obtain a negotiated service application. The access point 130 performs 520 an action based on one of the service request accepted message, the service request rejected message and a negotiated service application from the application server 105.

In an embodiment of the present invention, upon the activation of the application, the client 100 negotiates with the access point to determine the QoS parameters that are adequate for the requested application. When the client 100 negotiates QoS parameters for the application, the access point 130 may not have the requested information regarding the application. Based on the client's 100 provisioning, the access point 130 can agree or renegotiate new QoS parameters. Subsequently, the client 100 can choose to reject or activate the negotiated service application. For example, on examining the QoS parameters of the communication network 115 the client 100 may choose to access a lower resolution version of a multimedia application if a higher resolution version of the application is not available at that moment. Alternatively, the client 100 may opt for an audio-only version of the multimedia application or choose to reject the multimedia application.

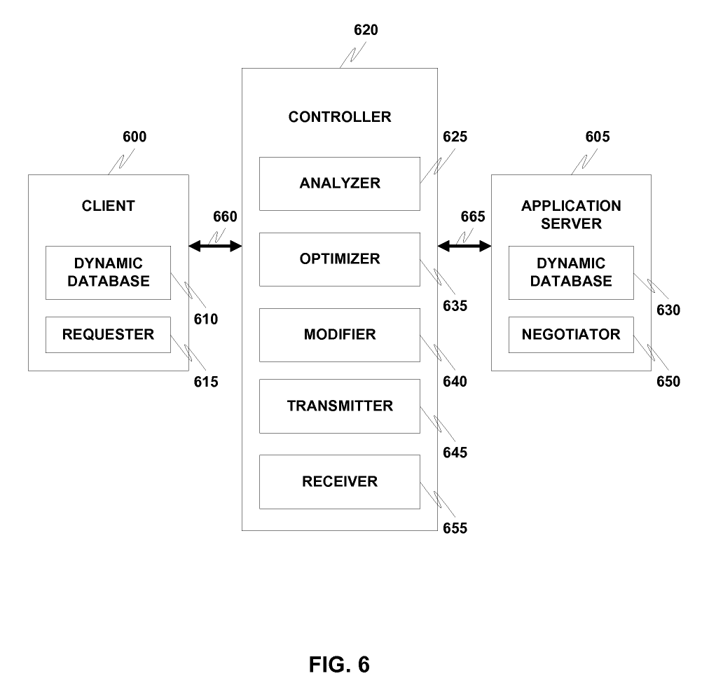

Turning now to FIG. 6, a block diagram of a system that facilitates optimization of a QoS for one or more applications is shown in accordance with an embodiment of the present invention. The system can comprise of one or more clients, one or more application servers and one or more dynamic databases. One of the clients is depicted as a client 600 and one of the application servers is depicted as an application server 605. The client 600 may wish to operate an application that is serviced by the application server 605. The application may require a certain QoS. In an embodiment of the present invention, a dynamic database 610 is generated at the client 600. The client 600 can use the dynamic database 610 to determine a desired traffic characteristics for the application. The client 600 can comprise a requester 615 that sends requests for the desired traffic characteristic to a controller 620. The controller 620 can reside on an access point of a communication network.

The controller 620 can comprise an analyzer 625, an optimizer 635, a modifier 640, a transmitter 645 and a receiver 655. The analyzer 625 analyses the desired traffic characteristics with the statistical information in the dynamic database 610. Those skilled in the art will realize that the dynamic database 610 may not necessarily reside on the client 600. A dynamic database can reside on the application server 605, for example dynamic database 630, or on the access point.

The optimizer 635 optimizes the QoS for the application configuring a connection between the client 600 and the application server 605 or re-deploying one or more network resources.

In an embodiment of the present invention, based on the analysis of the analyzer 625, the modifier 640 can modify the request based on the historical measurements of the traffic corresponding to the service application deployed at the application server 605. Moreover, the modifier 640 modifies the client request to obtain a modified request for the application.

The transmitter 645 at the controller 620 transmits the modified request to the application server 605. In an embodiment of the present invention, the application server 605 negotiates the service application with the client 600 using a negotiator 650 upon receiving the modified request from the controller 620. The negotiator 650 negotiates the service application based on the service application statistics to obtain the negotiated service application. In an embodiment of the present invention, the negotiator 650 can also reside on the controller 620 or on the client 600. The receiver 655 receives the negotiated service application. The receiver can also receive a request accepted message or a request rejected message. The controller 620 can then forward the negotiated service application, the request accepted message or the request rejected message to the client 600.

For example, the client 600 requests a video clip of a song from the application server 605. The statistical information regarding previous use of the requested application by the client 600 is obtained from the dynamic database 610 residing at the client 600. According to the obtained statistical information the current time is 8 AM and the communication network previously used was WLAN, though EV-DO was also available. Further, the application from the application server 605 used a bandwidth of 256 kbps on average. An audio vocoder previously used was mainly 32 kbps ADPCM (Adaptive Differential Pulse Code Modulation). A video vocoder previously used was mainly MPEG 2 (Moving Picture Experts Group) with a maximum variable rate of 256 kbps. Moreover, the average jitter was mapped to a 2 kilobytes buffer. From analyzing the statistical information the client 600 considers 32 kbps ADPCM vocoder. The client 600 considers MPEG 2 variable rate decoder with a maximum rate of 256 kbps. With an additional safety margin of 0.5 kilobytes, the client 600 allocates 2.5 kilobytes initially for jitter buffer. Furthermore, the client 600 requests the desired traffic characteristics to correspond to QoS of 300 kbps from the WLAN network with 3 kilobytes equivalent jitter. The client requested desired traffic characteristics is further passed to the application server 605 by tagging the request with the application and the client ID.

In response to the request made by the client 600, the application server 605 analyses the client request taking into account the statistical information from the client 600 and the current running application statistics. As a result of the analysis the application server 605 realizes that the new request could not exceed the average available resources. Consequently, the application server 605 instructs the communication network or the client 600 to reject the request or alternatively the application server 605 negotiates with the controller 620 and offers an audio-only capability of the requested song. The client 600 receives the new offered choice for the requested song. When the client 600 approves of the newly offered choice, the configuration of the application operating at the client 600 is modified in accordance with the negotiated parameters. Subsequently, the application server 605 activates the song requested by the client 600. The presented example provides a way to allocate the communication network in an optimized manner using QoS statistical information.

Various embodiments of the present invention provide a method and a system for optimizing resource allocations for applications based on the QoS needs of the applications and the QoS observations. An improvement in optimized resource allocation can guarantee timely delivery of requested applications to a plurality of clients. Moreover, an enhanced QoS can guarantee bandwidth for key applications and clients. Further, the need for employing additional network infrastructure for achieving higher speed and bandwidth may not be required. Better network planning can be devised from improved QoS.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The present invention is defined solely by the appended claims including any amendments made during the pendency of this application and all equivalents of those claims as issued.

1. A method of optimizing a Quality of Service (QoS) for an application accessible by a communication network, the method comprising:
generating a dynamic database of statistical information regarding at least one of the application and the communication network;
selecting the application to operate on the communication network;
analyzing the dynamic database to determine at least one network configuration based on a desired QoS requirement; and
connecting to the application based on the analysis of the at least one network configuration.

2. The method of claim 1 further comprising updating the dynamic database.

3. The method of claim 1 analyzing the dynamic database to determine at least one network configuration includes selecting a communication network from among a plurality of communication networks.

4. The method of claim 1 further comprising configuring parameters of the selected application based on the desired QoS.

5. The method of claim 1 wherein the QoS is a predefined set of statistics.

6. The method of claim 5 further comprising matching the predefined set of statistics with the statistical information in the dynamic database.

7. The method of claim 1, wherein the generating step comprises:
collecting at least one of an application statistics and a service application statistics, the application statistics corresponding to the application, the service application statistics corresponding to the service application, the statistical information in the database comprising at least one of the application statistics and the service application statistics;
creating performance classes; and
assigning at least one of the application statistics and the service application statistics into the performance classes.

8. The method of claim 7, wherein the application statistics comprises at least one of a client identification, an application identification, an identification corresponding to at least one communication network, a session identification, a session duration corresponding to the session, a location of the client, a usage frequency of the application, a resource availability in at least one communication network, a historical measurement of traffic corresponding to the service application, an application type and a client type.

9. The method of claim 7, wherein the service application statistics comprises at least one of a service application identification, an identification corresponding to at least one communication network, a session identification, a session duration corresponding to the session, a location of the application server, a throughput measurement of the service application, a time of the day corresponding to the session, a historical measurement of traffic corresponding to the service application, a resource availability in at least one communication network, at least one communication network load measurement or indication, a service application type and an application server type.

10. A method of customizing a Quality of Service (QoS) for an application, the method comprising:
determining a desired traffic characteristics for the application based on statistical information regarding at least one of the application, the service application and a communication network, wherein the desired traffic characteristic corresponds to a service application, the application being served by the service application, the service application being deployed at an application server, the statistical information residing on at least one dynamic database;
sending a request for the desired traffic characteristic for the application to an access point, the access point corresponding to the communication network; and
receiving a customized traffic characteristic for the application in response to the request for the desired traffic characteristic, the customized traffic characteristic corresponding to the service application.

11. The method of claim 10 further comprises:
modifying the request based on at least a historical measurement of traffic corresponding to the service application, the access point modifying the request to obtain a modified request for the application, the historical measurement of traffic being obtained from the at least one dynamic database;
transmitting the modified request to the application server; and
receiving one of a service request accepted message, a service request rejected message, a negotiated service application based on a service application statistics, the application server negotiating the service application based on the modified request and the service application statistics to obtain the negotiated service application.

12. The method of claim 11 further comprises:
performing an action based on the one of the service request accepted message, the service request rejected message and the negotiated service application from the application server.

13. The method of claim 10, wherein the at least one client performs one of an accepting the customized traffic characteristic and rejecting the customized traffic characteristic.

14. The method of claim 10, wherein the at least one client determines the desired traffic characteristics based on an application statistics, the application statistics being obtained from at least one dynamic database.

15. The method of claim 10, wherein the client requests the access point for the desired traffic attributes based on a historical measurement of traffic corresponding to the service application.

16. A system for optimizing a Quality of Service (QoS) for an application, the system comprising:
at least one client wherein the application operates on the at the at least one client;
at least one application server, a service application being deployed at the at least one application server;
a dynamic database including statistical information corresponding to at least one of the application and the service application, the service application serving the application for a session;
an analyzer for analyzing the statistical information; and
an optimizer for optimizing the QoS by performing one of, reconfiguring a connection between the client and the application server and re-deploying at least one network resource.

17. The system of claim 16, wherein the system further comprises:
a requester for sending a request for a desired traffic characteristic for the application, wherein the desired traffic characteristic corresponds to the service application.

18. The system of claim 17, wherein at least one of the database and the requesting module resides on the at least one client.

19. The system of claim 17 further comprises:
a modifier for modifying the request based on at least a historical measurement of traffic corresponding to the service application, a controller modifying the request to obtain a modified request for the application;
a transmitter for transmitting the modified request to the application server;
a negotiator for negotiating the service application based on the modified request and the service application statistics to obtain a negotiated service application; and
a receiver for receiving at least one of a request accepted message, a request rejected message and the negotiated service application based on a service application statistics.

20. The system of claim 19, wherein at least one of the dynamic database, the optimizer, the modifier, the transmitter and the receiver resides on an access point.
